(19) United States
(12) Patent Application Publication
(10) Pub. No.: US 2026/0181727 A1
(43) Pub. Date: Jun. 25, 2026

(54) ACCESS NETWORK NODE, CONTROL NODE, USER EQUIPMENT, AND CORE NETWORK NODE

(71) Applicant: NEC Corporation, Minato-ku, Tokyo (JP)

(72) Inventors: Toshiyuki TAMURA, Tokyo (JP); Hisash FUTAKI, Tokyo (JP)

(73) Assignee: NEC Corporation, Minato-ku, Tokyo (JP)

(21) Appl. No.: 18/729,603

(22) PCT Filed: Dec. 26, 2022
(86) PCT No.: PCT/JP2022/047931

§ 371 Date: Jul. 17, 2024

(30) Foreign Application Priority Data
Feb. 10, 2022 (JP) 2022-019381

(51) Int. Cl. H04W 84/04; H04W 4/90; H04W 48/16; H04W 48/18; H04W 76/11; H04W 76/50

(52) U.S. Cl. CPC H04W 84/042; H04W 4/90; H04W 48/16; H04W 48/18; H04W 76/11; H04W 76/50

(57) ABSTRACT

An access network node (12) receives a Non-Access Stratum (NAS) message sent from a User Equipment (UE) (31) and associated with a first Public Land Mobile Network (PLMN) (10). If no control node belonging to a core network (15) of the first PLMN (10) is selectable or available, the access network node (12) forwards the NAS message to a donor control node belonging to a core network (25) of a second PLMN (20). This allows, for example, a core network node belonging to a PLMN different from the PLMN selected by the UE to process the NAS message instead.

### TECHNICAL FIELD The present disclosure relates to wireless communication networks.

### BACKGROUND ART

Non-Patent Literature 1 discusses the support of Minimization of Service Interruption (MINT) by 5G systems and provides key issues and solutions for supporting MINT. Some of the solutions are related to Radio Access Network (RAN) sharing. For example, in Solution #10 described in Chapter 6.10 of Non-Patent Literature 1, when a disaster condition applies, a RAN node in a Public Land Mobile Network (PLMN) without the disaster condition is shared between the PLMN without the disaster condition and a PLMN with the disaster condition. In this case, User Equipments (UEs) that were served by the PLMN with the disaster condition can register to the same PLMN (i.e., the PLMN with the disaster condition) through the shared RAN.

Some other solutions disclosed in Non-Patent Literature 1 relate to a registration procedure to a PLMN without a disaster condition for disaster roaming. Non-Patent Literature 2 (e.g., Chapter 5.40), Non-Patent Literature 3 (e.g., Chapter 4.2.2.2), and Non-Patent Literature 4 (e.g., Chapters 3.1 and 3.10) also contain the following disclosures related to disaster roaming registration.

A UE supporting MINT can be configured with an activation of disaster roaming and a list of PLMN(s) to be used in disaster condition. Activation of disaster roaming is also referred to as an indication of whether disaster roaming is enabled in the UE.

Activation of disaster roaming is provided or performed by the Home PLMN of a UE. Activation of disaster roaming may be pre-configured in a Universal Subscriber Identity Module (USIM).

The list of PLMN(s) to be used in disaster condition may be pre-configured in a USIM. Alternatively, the list of PLMN(s) to be used in disaster condition may be provided to a UE by its HPLMN or a registered PLMN (RPLMN) through a successful registration procedure, or it may be provided to a UE after a successful registration procedure.

A Next Generation RAN (NG-RAN) in a PLMN that offers or provides disaster roaming services broadcasts an indication of accessibility for disaster roaming service. In addition, the NG-RAN providing disaster roaming services may broadcast a list of one or more PLMN(s) with disaster condition for which disaster roaming is offered by the available PLMN.

A UE determines a PLMN with disaster condition as follows. If the RPLMN of the UE is included in a list of one or more PLMN(s) with disaster condition for which disaster roaming is offered by the available PLMN, broadcast by any NG-RAN cell, the UE determines that the RPLMN is a PLMN with disaster condition. Otherwise, if the HPLMN, the highest priority Equivalent HPLMN (EHPLMN), any PLMN in the “User Controlled PLMN Selector with Access Technology” data file in the USIM, any PLMN in the “Operator Controlled PLMN Selector with Access Technology” data file in the USIM, or any other PLMN is included in a list of one or more PLMN(s) with disaster condition for which disaster roaming is offered by the available PLMN, broadcast by any NG-RAN cell, the UE determines that this PLMN is a PLMN with disaster condition.

The UE shall attempt disaster roaming (or select PLMN for disaster roaming) only if:
there is no available PLMN which is allowable;
the UE is configured with activation of disaster roaming;
the UE is not registered over non-3GPP access connected to a 5G Core network (CN); and
a PLMN included in a list of PLMN(s) to be used in disaster condition, associated with a determined PLMN with disaster condition, is able to accept disaster inbound roamers from the determined PLMN with disaster condition.

If an NG-RAN cell of a PLMN without disaster condition is broadcasting disaster-related information, the UE may select this PLMN without disaster condition for a disaster roaming attempt. Alternatively, if an NG-RAN cell of a PLMN without disaster condition is broadcasting a list of one or more PLMN(s) with disaster condition for which disaster roaming is offered by the available PLMN, and if the list includes the determined PLMN with disaster condition, the UE may select this PLMN without disaster condition for a disaster roaming attempt.

### CITATION LIST

### Non-Patent Literature

[Non-Patent Literature 1] 3GPP TR 24.811 V17.1.0(2021-09) “3rd Generation Partnership Project; Technical Specification Group Core Network and Terminals; Study on the support for minimization of service interruption; (Release 17)”, September 2021
[Non-Patent Literature 2] 3GPP TS 23.501 V17.3.0(2021-12) “3rd Generation Partnership Project; Technical Specification Group Services and System Aspects; System architecture for the 5G System (5GS); Stage 2 (Release 17)”, December 2021
[Non-Patent Literature 3] 3GPP TS 23.502 V17.3.0(2021-12) “3rd Generation Partnership Project; Technical Specification Group Services and System Aspects; Procedures for the 5G System (5GS); Stage 2 (Release 17)”, December 2021
[Non-Patent Literature 4] 3GPP TS 23.122 V17.5.0(2021-12) “3rd Generation Partnership Project; Technical Specification Group Core Network and Terminals; Non-Access-Stratum (NAS) functions related to Mobile Station (MS) in idle mode (Release 17)”, December 2021

### SUMMARY OF INVENTION

### Technical Problem

The inventors have studied MINT, disaster roaming, and similar technologies and identified many problems. One of the problems is related to the selection of a core network node (e.g., Access and Mobility Management Function (AMF)) by a RAN node. When a RAN node receives an initial Non-Access Stratum (NAS) message (e.g., Registration Request, Service Request) from a UE, it selects a core network node (e.g., AMF) belonging to a PLMN selected by the UE according to a predetermined rule and forwards the NAS message to the selected AMF. However, there may be cases where a RAN node cannot select or use any of the core network nodes belonging to the PLMN selected by the UE, for example due to natural or human-caused disasters. In such cases, if a core network node belonging to a PLMN other than the one selected by the UE can process NAS messages instead, this could contribute to improved service continuity for the UE. This also has the advantage that it does not necessarily require the UE to support new technologies such as MINT and disaster roaming described above. However, current options do not allow this to be achieved.

Another problem concerns the use of a network slice in disaster roaming. In particular, it is not clear how disaster roamer UEs know which network slices are available to them in a PLMN without disaster condition (or a PLMN offering disaster roaming) to attempt disaster roaming.

Another problem relates to improved disaster roaming procedures. For example, if a core network node (e.g., AMF) of a PLMN offering disaster roaming receives a request for disaster roaming registration from a UE, the core network node may need to access a subscriber server or database (e.g., Unified Data Management (UDM)) of the UE's HPLMN to retrieve the UE's subscription data. However, there are cases where there is no roaming agreement between the PLMN offering disaster roaming and the HPLMN, in which case the UDM of the HPLMN may reject the request from the core network node of the PLMN offering disaster roaming. It is desirable to avoid this situation.

One of the objects to be achieved by the example embodiments disclosed herein is to provide apparatuses, methods, and programs that contribute to solving at least one of the above-described problems. It should be noted that this object is merely one of the objects to be achieved by the example embodiments disclosed herein. Other objects or problems and novel features will become apparent from the following description and the accompanying drawings.

### Solution to Problem

In a first aspect, an access network node includes a first communication interface, a second communication interface, and at least one processor. The first communication interface is configured to communicate with a plurality of UEs through a cell. The second communication interface is configured to be connected to a first core network of a first PLMN and to a second core network of a second PLMN different from the first PLMN. The at least one processor is configured to receive a Non-Access Stratum message sent from a UE and associated with the first PLMN, and if no control node belonging to the first core network of the first PLMN is selectable or available, forward the Non-Access Stratum message to a donor control node belonging to the second core network of the second PLMN.

In a second aspect, a method performed by an access network node includes the steps of:
(a) connecting to a first core network of a first PLMN and to a second core network of a second PLMN different from the first PLMN;
(b) receiving a Non-Access Stratum message sent from a UE and associated with the first PLMN; and
(c) if no control node belonging to the first core network of the first PLMN is selectable or available, forwarding the Non-Access Stratum message to a donor control node belonging to the second core network of the second PLMN.

In a third aspect, a control node to be used in a core network of a first PLMN includes a communication interface and at least one processor. The communication interface is configured to be connected to an access network node. The at least one processor is configured to send a control message to the access network node specifying a donor control node belonging to a core network of a second PLMN different from the first PLMN to which the control node belongs. The control message causes the access network node to, if no control node belonging to the core network of the first PLMN is selectable or available, forward to the donor control node of the second PLMN a Non-Access Stratum message that is transmitted from a UE and is associated with the first PLMN.

In a fourth aspect, a method performed by a control node used in a core network of a first PLMN includes sending a control message to an access network node specifying a donor control node belonging to a core network of a second PLMN different from the first PLMN to which the control node belongs. The control message causes the access network node to, if no control node belonging to the core network of the first PLMN is selectable or available, forward to the donor control node of the second PLMN a Non-Access Stratum message that is transmitted from a UE and is associated with the first PLMN.

In a fifth aspect, a UE includes at least one memory and at least one processor coupled to the at least one memory. The at least one processor is configured to store in the at least one memory a list of one or more PLMNs to be used during a disaster condition. The at least one processor is configured to store in the at least one memory a list of one or more network slice identifiers for disaster roaming associated with each PLMN in the list of one or more PLMNs. The at least one processor is configured to select a PLMN for disaster roaming from the list of one or more PLMNs. The at least one processor is configured to select at least one network slice identifier for disaster roaming from the list of one or more network slice identifiers for disaster roaming associated with the selected PLMN for disaster roaming. The at least one processor is configured to transmit a registration request message indicating the selected PLMN for disaster roaming and indicating the selected network slice identifier for disaster roaming to a core network of the selected PLMN for disaster roaming.

In a sixth aspect, a method performed by a UE includes the steps of:
(a) storing in the at least one memory a list of one or more PLMNs to be used during a disaster condition;
(b) storing in the at least one memory a list of one or more network slice identifiers for disaster roaming associated with each PLMN in the list of one or more PLMNs;
(c) selecting a PLMN for disaster roaming from the list of one or more PLMNs;
(d) selecting at least one network slice identifier for disaster roaming from the list of one or more network slice identifiers for disaster roaming associated with the selected PLMN for disaster roaming; and
(e) transmitting a registration request message indicating the selected PLMN for disaster roaming and indicating the selected network slice identifier for disaster roaming to a core network of the selected PLMN for disaster roaming.

In a seventh aspect, a core network node of an HPLMN of a UE or an RPLMN to which the UE is registered includes at least one memory and at least one processor coupled to the at least one memory. The at least one processor is configured to provide the UE with a first list of one or more PLMNs to be used during a disaster condition. The at least one processor is further configured to provide the UE with a second list of one or more network slice identifiers for disaster roaming associated with each PLMN in the list of one or more PLMNs.

In an eighth aspect, a method performed by a core network node of an HPLMN of a UE or an RPLMN to which the UE is registered includes the steps of:
(a) providing the UE with a first list of one or more PLMNs to be used during a disaster condition; and
(b) providing the UE with a second list of one or more network slice identifiers for disaster roaming associated with each PLMN in the list of one or more PLMNs.

In a ninth aspect, an access network node of a PLMN offering disaster roaming includes at least one memory and at least one processor coupled to the at least one memory. The at least one processor is configured to broadcast disaster-related information in a cell indicating that disaster roaming is offered. The disaster-related information includes a list of one or more network slice identifiers for disaster roaming.

In a tenth aspect, a method performed by an access network node of a PLMN offering disaster roaming includes broadcasting disaster-related information in a cell indicating that disaster roaming is offered. The disaster-related information includes a list of one or more network slice identifiers for disaster roaming.

In an eleventh aspect, a core network node of a PLMN offering disaster roaming includes at least one memory and at least one processor coupled to the at least one memory. The at least one processor is configured to receive a registration request from a UE and to, if the registration request indicates disaster roaming, include an indication of disaster roaming in a message to be sent to a control node that is located in a Home PLMN of the UE and manages subscription information for the UE.

In a twelfth aspect, a method performed by a core network node in a PLMN offering disaster roaming includes receiving a registration request from a UE and, if the registration request indicates disaster roaming, including an indication of disaster roaming in a message to be sent to a control node that is located in a Home PLMN of the UE and manages subscription information for the UE.

In a thirteenth aspect, a program includes a set of instructions (software codes) that, when loaded into a computer, cause the computer to perform the method according to the second, fourth, sixth, eighth, tenth, or twelfth aspect described above.

### Advantageous Effects of Invention

According to the aspects described above, it is possible to provide apparatuses, methods and programs that contribute to solving at least one of the problems described above.

### BRIEF DESCRIPTION OF DRAWINGS

FIG. 1 shows an example configuration of a network system according to an example embodiment;

FIG. 2 is a flowchart showing an example of the operation of a RAN node according to an example embodiment;

FIG. 3 is a sequence diagram showing an example of the operation of a RAN node and a core network node according to an example embodiment;

FIG. 4 is a sequence diagram showing an example of the operation of a RAN node and a core network node according to an example embodiment;

FIG. 5 shows an example configuration of a network system according to an example embodiment;

FIG. 6 is a flowchart showing an example of the operation of a UE according to an example embodiment;

FIG. 7 is a flowchart showing an example of the operation of a UE according to an example embodiment;

FIG. 8 is a diagram showing an example of signaling regarding disaster roaming according to an example embodiment;

FIG. 9 is a diagram showing an example of signaling regarding disaster roaming according to an example embodiment;

FIG. 10 is a diagram showing an example of signaling regarding disaster roaming according to an example embodiment;

FIG. 11 is a diagram showing an example configuration of a RAN node according to an example embodiment;

FIG. 12 is a diagram showing an example configuration of a core network node according to an example embodiment; and

FIG. 13 is a diagram showing an example configuration of a UE according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are primarily described for the 3GPP (registered trademark) LTE system and the 5G system. However, these example embodiments can be applied to other network systems. For example, these example embodiments can be applied to other network systems that support technologies similar to 3GPP MINT and disaster roaming. The term LTE as used in this specification includes enhancements and developments of LTE and LTE-Advanced to enable interworking with the 5G system, unless otherwise noted.

As used in this specification, “if” can be interpreted to mean “when”, “at or around the time”, “after”, “upon”, “in response to determining”, “in accordance with a determination”, or “in response to detecting”, depending on the context.

### First Example Embodiment

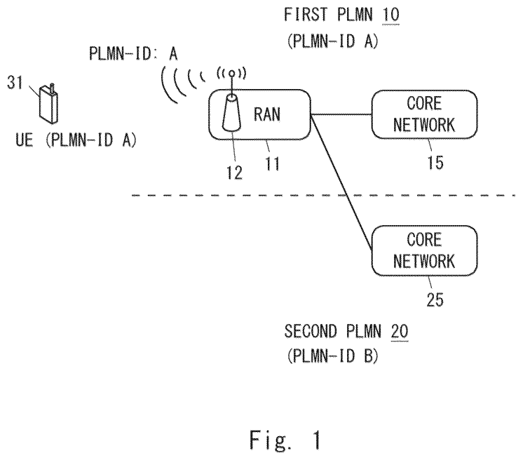

FIG. 1 shows an example configuration of a network system according to this example embodiment. Each of the elements shown in FIG. 1 is a network function, for example providing an interface as defined by 3GPP. Each element (or network function) shown in FIG. 1 can be implemented, for example, as a network element on dedicated hardware, as a software instance running on dedicated hardware, or as a virtualized function instantiated on an application platform.

The network system shown in FIG. 1 includes a RAN 11 and a core network 15. The RAN 11 may be a Next Generation Radio Access Network (NG-RAN), an Evolved Universal Mobile Telecommunications System (UMTS) Terrestrial Radio Access Network (E-UTRAN), or a radio access network in another network system, or any combination thereof. The core network 15 may be a 5G Core (5GC), an Evolved Packet Core (EPC), or a core network in another network system, or any combination thereof.

The RAN 11 includes one or more RAN nodes 12. The one or more RAN nodes 12 may be gNBs or eNBs, or both. The core network 15 includes one or more core network nodes. These core network nodes include one or more control plane nodes and one or more user plane (or data plane) nodes. In the case of a 5G system, the control plane nodes include an Access and Mobility Management Function (AMF), a Session Management Function (SMF), and other nodes (e. g., Unified Data Management (UDM) and Policy Control Function (PCF)), while the user plane nodes include a User Plane Function (UPF). In the case of an LTE system, the control plane nodes include a Mobility Management Entity (MME) and other nodes (e.g., Home Subscriber Server (HSS) and Policy and Charging Rules Function (PCRF)), while the user plane nodes include a Serving Gateway (S-GW) and a Packet Data Network Gateway (P-GW).

As shown in FIG. 1, the core network 15 is provided by a first PLMN 10. As an example and not a limitation, the RAN 11 may also be provided by the first PLMN 10. However, the RAN 11 may be provided by an operator (e.g., RAN operator) other than the first PLMN 10 and other than a second PLMN 20 described below. For example, the core network 15 of the first PLMN 10 may be provided by a (full) Mobile Virtual Network Operator (MVNO) and utilize the RAN 11 operated by another operator. In the example of FIG. 1, the PLMN identity (ID) of the first PLMN 10 is “A”. One or more RAN nodes 12 in the RAN 11 broadcast, in their respective cells, system information including a set or list of one or more PLMNs. This PLMN list indicates the PLMNs available in each cell. In the example in FIG. 1, the PLMN list broadcast by the RAN node 12 includes at least PLMN ID “A”. The list need not include PLMN ID “B” of the second PLMN 20 described below.

A UE 31 can use the first PLMN 10. The Home PLMN (HPLMN) or Equivalent HPLMN (EHPLMN) of the UE 31 may be the first PLMN 10. Alternatively, the HPLMN of the UE 31 may be another PLMN that has a roaming agreement with the first PLMN 10. The UE 31 may be a UE authorized to register as an inbound roamer with the first PLMN 10. The UE 31 need not have an explicit roaming agreement with the second PLMN 20 described below. There may be multiple UEs 31.

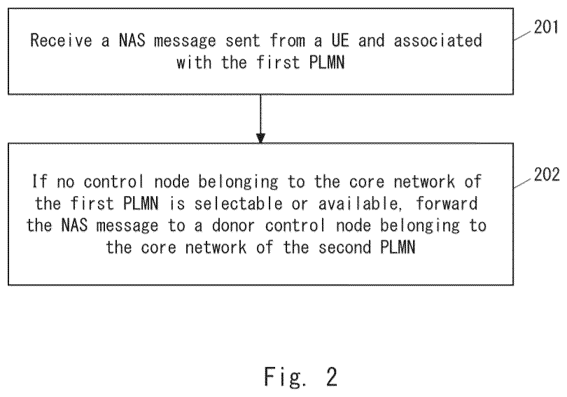

FIG. 2 shows an example of the operation of the RAN node 12.

In step 201, the RAN node 12 receives a NAS message sent from the UE 31 and associated with the first PLMN 10. The NAS message may be, for example, a Registration Request message. The NAS message can be associated with the first PLMN 10 or the PLMN ID “A” by being included with the PLMN ID “A” in a Radio Resource Control (RRC) message. Specifically, the RAN node 12 receives from the UE 31 an RRC message, e.g., RRC Setup Complete message, containing the NAS message. The RRC Setup Complete message contains the PLMN ID “A” or another identifier that contains the PLMN ID “A”, e. g., Globally Unique AMF ID (GUAMI).

If a control node (e.g., AMF) belonging to the core network 15 of the first PLMN 10 is selected according to a predetermined rule, the RAN node 12 forwards the NAS message to the selected control node. On the other hand, if no control node belonging to the core network 15 of the first PLMN 10 is selectable or available, as shown in step 202, the RAN node 12 forwards the NAS message to a donor control node (e.g., donor AMF) belonging to a core network 25 of the second PLMN 20. The term donor control node is an example and may be referred to by other names.

For example, the donor control node may recognize that the received NAS message requests registration to the first PLMN 10, which is different from the second PLMN 20, but may not reject the NAS message and treat the UE 31 as if it is an inbound roamer to the second PLMN 20. The core network 25 of the second PLMN 20, including the donor control node, may provide home routed roaming to the UE 31. In other words, the donor control node in the core network 25 may exchange signaling with the RAN 11 and the core network 15, either directly or through other network functions, to establish a user plane connection through the RAN 11, a user plane node in the core network 25 of the second PLMN 20, and an (anchor) user plane node in the core network 15 of the first PLMN 10. The user plane connection may be a Protocol Data Unit (PDU) Session or an Evolved Packet System (EPS) bearer. Alternatively, the core network 25 may provide local breakout roaming to the UE 31. In other words, the donor control node in the core network 25 may exchange signaling with the RAN 11 and the core network 15, either directly or through other network functions, to establish a user plane connection through the RAN 11 and an (anchor) user plane node in the core network 25 of the second PLMN 20. The donor control node may operate in this manner based on an agreement between the operator of the second PLMN 20 and the operator of the first PLMN 10.

The following describes the procedure for configuring a donor control node in the RAN node 12. In some implementations, the RAN node 12 may receive a control message from a control node (e.g., AMF) belonging to the core network 15 of the first PLMN 10 that specifies a donor control node belonging to the core network 25 of the second PLMN 20. The RAN node 12 may receive the control message described above in a procedure for setting up or updating configuration data required for interoperation between the control node belonging to the core network 15 and the RAN node 12. In the case of a 5G system, this procedure may be an NG Setup procedure, a RAN Configuration Update procedure, or an AMF Configuration Update procedure.

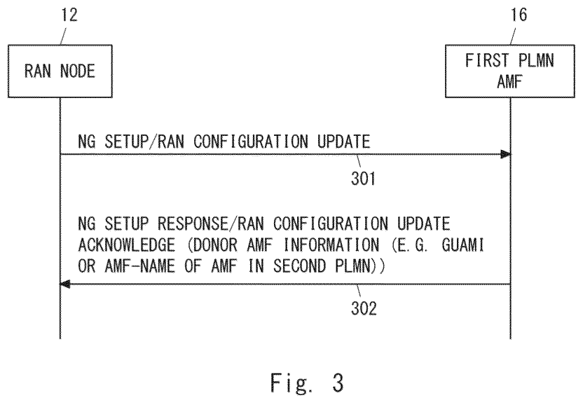

In the example of FIG. 3, the RAN node 12 sends an NG SETUP message or a RAN CONFIGURATION UPDATE message to an AMF 16, which is a control node of the first PLMN 10 (step 301). The AMF 16 responds to the RAN node 12 with an NG SETUP RESPONSE message or a RAN CONFIGURATION UPDATE ACKNOWLEDGE message (step 302). The NG SETUP RESPONSE message or the RAN CONFIGURATION UPDATE ACKNOWLEDGE message contains donor AMF information. The donor AMF information specifies the donor control node (i.e., donor AMF) belonging to the core network 25 of the second PLMN 20. The donor AMF information may include a name of the donor AMF (e.g., AMF Name). The AMF Name uniquely identifies the AMF. The AMF Name may be used as a human-readable name. In addition or alternatively, the donor AMF information may include an identifier (e. g., GUAMI) of the donor AMF. When there are multiple donor AMFs, the AMF 16 may provide a list of multiple donor AMFs to the RAN node 12. In other words, when there are multiple donor AMFs, the donor AMF information may include a list of multiple donor AMFs.

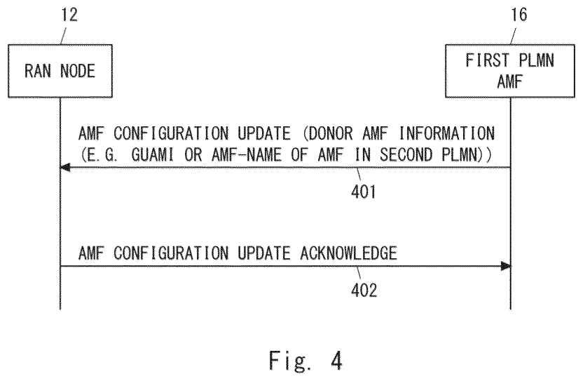

In the example of FIG. 4, the RAN node 12 receives an AMF CONFIGURATION UPDATE message from the AMF 16 of the first PLMN 10 (step 401). The AMF CONFIGURATION UPDATE message in step 401 contains donor AMF information. The donor AMF information specifies the donor control node (i.e., donor AMF) belonging to the core network 25 of the second PLMN 20. The donor AMF information may include one or both of the name (e.g., AMF Name) and the identifier (e.g., GUAMI) of the donor AMF. If there are multiple donor AMFs, the donor AMF information may include a list of multiple donor AMFs. The RAN node 12 responds to AMF 16 with an AMF CONFIGURATION UPDATE ACKNOWLEDGE message (step 402).

In other implementations, the RAN node 12 may receive a control message from a control node belonging to the core network 25 of the second PLMN 20 (e.g., a donor control node itself) indicating that a particular control node belonging to the core network 25 of the first PLMN 10 will act as a donor control node for the first PLMN 10. The RAN node 12 may receive this control message in a procedure for setting up or updating configuration data required for interoperation between the control node belonging to the core network 25 and the RAN node 12. In the case of a 5G system, this procedure may be an NG Setup procedure, a RAN Configuration Update procedure, or an AMF Configuration Update procedure.

The control node (e.g., donor control node) within the core network 25 may notify the RAN node 12 of a donor indicator indicating that it is capable of operating as a donor AMF, and information about a supported PLMN or a list of supported PLMNs for which it is capable of operating as a donor. In the case of a 5G system, the notification may be included in an NG SETUP RESPONSE message, a RAN CONFIGURATION UPDATE ACKNOWLEDGE message, or an AMF CONFIGURATION UPDATE message.

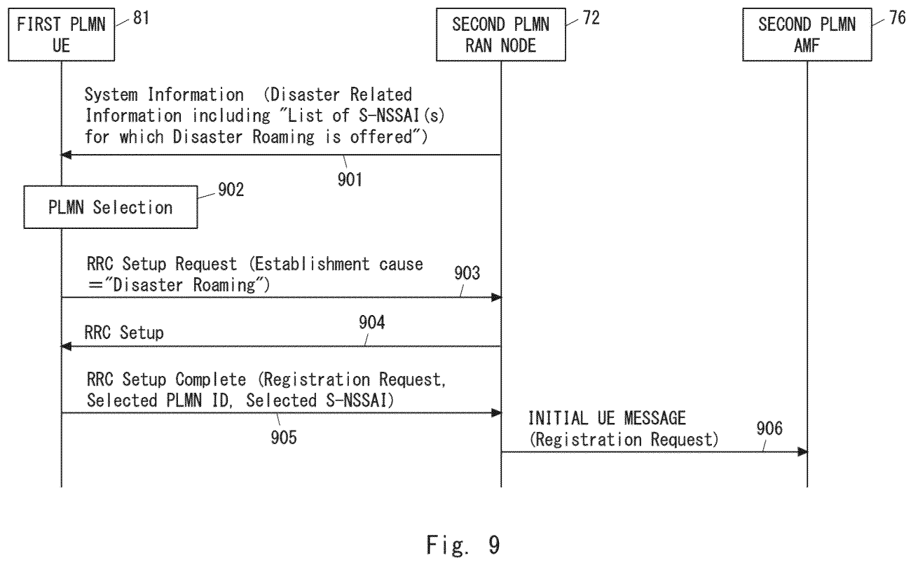

The NG interface between the RAN node 12 and a control node (e.g., a donor control node) in the core network 25 of the second PLMN 20 may be established (or set up) upon the occurrence of a disaster. For example, the NG interface may be established (or set up) upon the RAN node 12 broadcasting system information containing disaster-related information. This procedure corresponds to step 901 of the procedure in FIG. 9 below. As another example, the NG interface may be established (or set up) in response to the RAN node 12 receiving an RRC Setup Request message indicating “Disaster Roaming”. This procedure corresponds to step 903 of the procedure described in FIG. 9 below.

For example, due to natural or human-caused disasters, there may be cases where the RAN node 12 is unable to select or use any control node (e.g., AMF) belonging to the core network of the first PLMN 10 selected by the UE 31. The operations and procedures of the RAN node 12 and the core network node (e.g., AMF 16) described in this example embodiment allow the RAN node 12 to request a donor control node belonging to the second PLMN 20, which is different from the PLMN 10 selected by the UE 31, to process NAS messages of the UE 31 instead. This can potentially help to improve service continuity to the UE 31. This also has the advantage that the UE 31 does not necessarily need to support new technologies such as MINT and disaster roaming.

As an example and not a limitation, the first PLMN 10 may be a PLMN (e.g., commercial PLMN) managed by a private operator (or a commercial operator). In contrast, the second PLMN 20 providing a donor control node may be a PLMN (e.g., governmental PLMN) administered by a government agency. The government authority may be a national, federal, state, or local government authority. Alternatively, the second PLMN20 may be provided by another public agency, such as a public safety, public protection, or disaster relief organization. The donor control node may be equipped with a battery of sufficient capacity to continue service in the event of a loss of power due to a natural or human-caused disaster (e.g., flood, earthquake, tsunami, volcanic eruption, fire, gas explosion). In such a network deployment, the PLMN 20 provided by a government or public agency can improve the continuity or robustness of communication services to UEs 31 of users of private operators.

### Second Example Embodiment

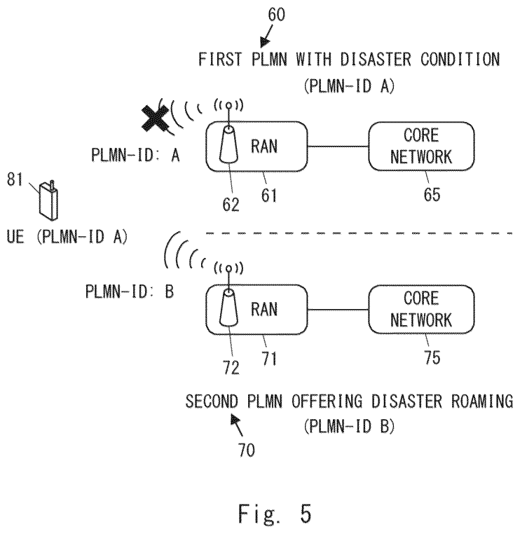

FIG. 5 shows an example configuration of a network system according to this example embodiment. Each of the elements shown in FIG. 5 is a network function, for example providing an interface as defined by 3GPP. Each element (or network function) shown in FIG. 1 can be implemented, for example, as a network element on dedicated hardware, as a software instance running on dedicated hardware, or as a virtualized function instantiated on an application platform.

The network system shown in FIG. 5 includes a first PLMN 60 including a RAN 61 and a core network 65. The network system shown in FIG. 5 further includes a second PLMN 70 including a RAN 71 and a core network 75. The RAN 71 may be an NG-RAN, an E-UTRAN, or a radio access network in another network system, or any combination thereof. The RAN 61 may be an NG-RAN, an E-UTRAN, or a radio access network in another network system, or any combination thereof. The core network 65 may be a 5GC, an EPC, or a core network in another network system, or any combination thereof. Similarly, the core network 75 may be a 5GC, an EPC, or a core network in another network system, or any combination thereof. The RAN 61 includes one or more RAN nodes 62. The RAN 71 includes one or more RAN nodes 72.

A UE 81 can use the first PLMN 60. The HPLMN or EHPLMN of the UE 81 may be the first PLMN 60. Alternatively, the HPLMN of the UE 81 may be another PLMN that has a roaming agreement with the first PLMN 60. The UE 81 may be a UE authorized to register as an inbound roamer with the first PLMN 60. The UE 81 need not have an explicit roaming agreement with the second PLMN 70. There may be multiple UEs 81.

In this example embodiment, the second PLMN 70 offers disaster roaming in a cell of the RAN node 72 of the RAN 71. For example, if a failure condition applies to an area to which a cell of the RAN node 62 of the first PLMN 60 and a cell of the RAN node 72 of the second PLMN 70 belong, and if the RAN node 62 of the first PLMN 60 is unavailable, the RAN node 72 of the second PLMN 70 may provide (or offer) disaster roaming to users who are registered in or able to use the first PLMN 60.

The RAN nodes 72 offering disaster roaming broadcast disaster-related information. The disaster-related information includes an indication of accessibility for disaster roaming service. In addition, the disaster-related information includes a list of one or more PLMN(s) with disaster condition for which disaster roaming is offered by the available PLMN(s). The list includes at least the first PLMN 60.

In addition, in this example embodiment, the disaster-related information includes a list of one or more network slice identifiers for disaster roaming. Each network slice identifier may be Single Network Slice Selection Assistance Information (S-NSSAI). For example, the list may be a List of S-NSSAI(s) for Disaster Roaming. The S-NSSAI(s) for disaster roaming are identifier(s) of network slices that provide disaster roaming. The S-NSSAI(s) for disaster roaming are identifier(s) of network slices provided by the PLMN for disaster roaming and available for disaster roaming to disaster inbound roamers. In addition or alternatively, the disaster-related information may include a list of S-NSSAI(s) for which disaster roaming is offered. The S-NSSAI(s) for which disaster roaming is offered are identifier(s) of network slices of PLMN(s) to which a disaster condition applies (or PLMN(s) that are in/have a disaster condition).

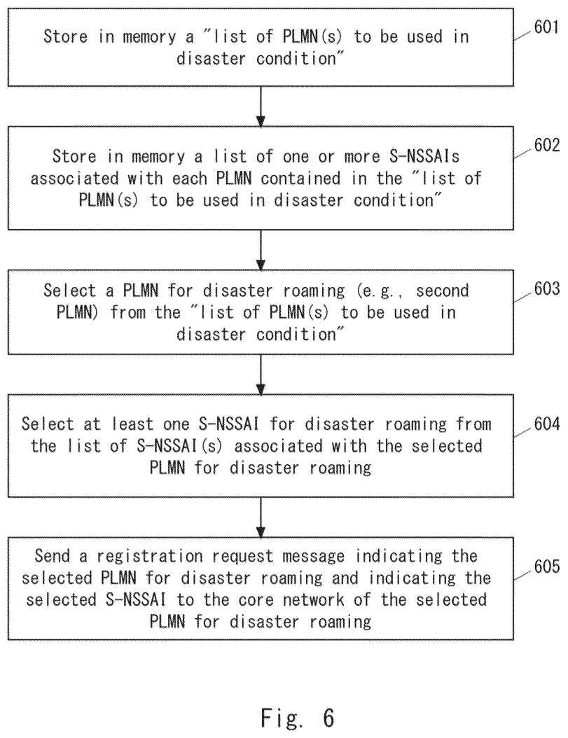

FIG. 6 shows an example of the operation of the UE 81.

In step 601, the UE 81 stores in memory (e.g., USIM) a list of PLMN(s) to be used in disaster condition. In step 602, the UE 81 stores in memory a list of one or more S-NSSAIs associated with each PLMN included in the list of PLMN(s) to be used in disaster condition. That is, the stored list of one or more S-NSSAIs includes S-NSSAI(s) that are valid in the associated PLMN.

The order of steps 601 and 602 is not limited. Steps 601 and 602 may be performed substantially simultaneously. For example, the UE 81 may receive the list of PLMN(s) to be used in disaster condition and the list of S-NSSAI(s) from an AMF of its HPLMN or RPLMN in a single NAS message (e.g., Registration Accept or UE Configuration Update Command). The HPLMN or RPLMN of the UE 81 may be the first PLMN 60.

The specific structure of the PLMN list in step 601 and the S-NSSAI list in step 602 is not limited. For example, the PLMN list in step 601 and the S-NSSAI list in step 602 may be a single integrated list. In other words, the UE 81 may store a list of one or more combinations, each of which is a combination of a PLMN to be used during a disaster condition and one or more S-NSSAIs for disaster roaming. The UE 81 may receive such a list of one or more combinations from the HPLMN or RPLMN.

Steps 603-605 may be performed when the UE 81 determines a PLMN with disaster condition. For example, if the RPLMN of the UE 81 is included in the “list of one or more PLMN(s) with disaster condition for which disaster roaming is offered by the available PLMN”, broadcast by any cell, the UE 81 may determine that the RPLMN is a PLMN with disaster condition. Otherwise, if the HPLMN, the highest priority EHPLMN, any PLMN in the “User Controlled PLMN Selector with Access Technology” data file in the USIM, any PLMN in the “Operator Controlled PLMN Selector with Access Technology” data file in the USIM, or any other PLMN is included in the “list of one or more PLMN(s) with disaster condition for which disaster roaming is offered by the available PLMN”, broadcast by any cell, the UE 81 may determine that this PLMN is a PLMN with disaster condition.

In step 603, the UE 81 selects a PLMN for disaster roaming (e.g., the second PLMN 70) from the list of PLMN(s) to be used in disaster condition associated with the determined PLMN with disaster condition (e.g., the first PLMN 60). If a PLMN (e.g., the second PLMN 70) included in the list of PLMN(s) to be used in disaster condition is capable of accepting disaster inbound roamers from the determined PLMN with disaster condition, the UE 81 may select that PLMN. In particular, if a cell in a PLMN without disaster condition (e.g., the second PLMN 70) broadcasts disaster-related information (e.g., an indication of accessibility for disaster roaming service), the UE 81 may select that PLMN without disaster condition for the disaster roaming attempt. Alternatively, if a cell in a PLMN without disaster condition (e.g., the second PLMN 70) broadcasts a list of one or more PLMN(s) with disaster condition for which disaster roaming is offered by the available PLMN, and if that list includes the determined PLMN with disaster condition (e.g., the first PLMN 60), the UE may select that PLMN without disaster condition (e.g., the second PLMN 70) for the disaster roaming attempt.

In step 604, the UE 81 selects at least one S-NSSAI for disaster roaming from the list of S-NSSAI(s) associated with the selected PLMN for disaster roaming.

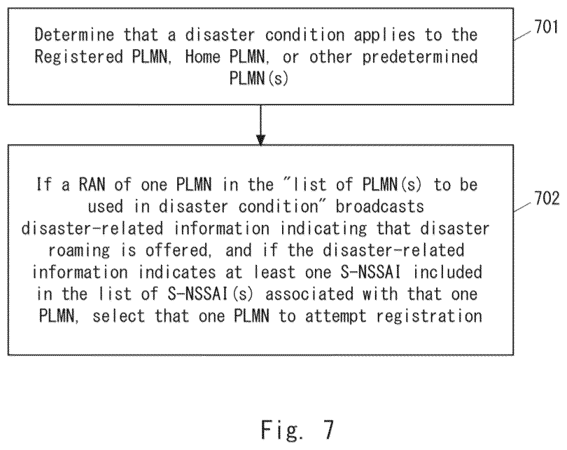

The order of steps 603 and 604 is not limited. Steps 603 and 604 may be performed substantially simultaneously. For example, when selecting a PLMN for disaster roaming in step 603, the UE 81 may consider the disaster roaming S-NSSAI(s) provided by a candidate disaster roaming PLMN. Specifically, the UE 81 may operate as shown in FIG. 7. In step 701, the UE 81 determines that a disaster condition applies to the Registered PLMN, Home PLMN, or other predetermined PLMN(s). In step 702, if a RAN of one PLMN in the stored list of one or more PLMNs (i.e., the list of PLMN(s) to be used in disaster condition) broadcasts disaster-related information indicating that disaster roaming is offered, and if the disaster-related information indicates at least one S-NSSAI included in the stored list of one or more S-NSSAIs associated with that one PLMN, the UE 81 selects that one PLMN for the disaster roaming attempt.

Returning to FIG. 6, in step 605, the UE 81 transmits a registration request message indicating the selected PLMN for disaster roaming and the selected S-NSSAI to the core network (e.g., core network 75) of the selected PLMN for disaster roaming (e.g., second PLMN 70). This allows the UE 81 to notify a core network node (e.g., AMF) in the PLMN for disaster roaming of the disaster roaming S-NSSAI desired by the UE 81.

Specifically, the UE 81 may transmit an RRC message containing the registration request message and containing the selected disaster roaming network slice identifier to the RAN (e.g., RAN 71) of the selected disaster roaming PLMN (e.g., second PLMN 70). The RRC message may be an RRC setup complete message. This allows the UE 81 to inform a RAN node (e.g., RAN node 72) in the PLMN for disaster roaming of the disaster roaming S-NSSAI desired by the UE 81.

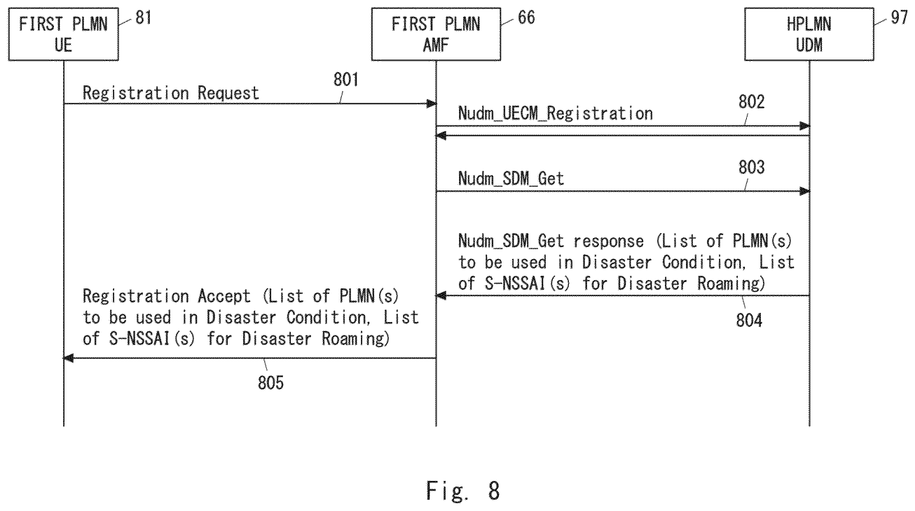

FIG. 8 shows a registration procedure under a normal situation where no disaster condition is applied to the HPLMN, RPLMN, etc. of the UE 81.

In step 801, the UE 81 sends a Registration Request message to an AMF 66, which is a control node of the first PLMN 60.

In step 802, the AMF 66 registers in a UDM 97 in the HPLMN of the UE 81. Specifically, the AMF 66 sends an Nudm_UECM_Registration to the UDM 97.

In step 803, the AMF 66 sends an Nudm_SDM_Get to the UDM 97 to request subscription data for the UE 81 from the UDM 97.

In step 804, the UDM 97 provides the requested subscription data for the UE 81 to the AMF 66. The subscription information includes a list of PLMN(s) to be used in disaster condition associated with the first PLMN 60. The subscription information further includes a list of S-NSSAI(s) for disaster roaming.

In step 805, the AMF 66 sends a Registration Accept message to the UE 81. The Registration Accept message contains the list of PLMN(s) to be used in disaster condition and the list of S-NSSAI(s) for disaster roaming.

The procedure in FIG. 8 is an example and may be modified as appropriate. As described previously, the list of PLMN(s) to be used in disaster condition and the list of S-NSSAI(s) for disaster roaming included in the Registration Accept message may be a single, integrated list. For example, the AMF 66 of the first PLMN 60 may create the list of PLMN(s) to be used in disaster condition associated with the first PLMN 60 according to a local configuration. For example, the AMF 66 of the first PLMN 60 may create the list of PLMN(s) to be used in disaster condition associated with the first PLMN 60 with reference to a local configuration and the subscription information received in step 804. Similarly, the AMF 66 of the first PLMN 60 may create a list of S-NSSAI(s) for disaster roaming associated with each PLMN included in the list of PLMN(s) to be used in disaster condition in accordance with a local configuration. The AMF 66 of the first PLMN 60 may create a mapping between the S-NSSAI(s) of each PLMN offering disaster roaming and the S-NSSAI(s) of the HPLMN and provide it to the UE 81.

FIG. 9 shows the PLMN selection by the UE 81 for disaster roaming and the disaster roaming attempt to the selected PLMN.

In step 901, the RAN node 72 of the second PLMN 70 offering disaster roaming broadcasts system information containing disaster-related information. The disaster-related information may include a list of S-NSSAI(s) for disaster roaming. In addition or alternatively, the disaster-related information may include a list of S-NSSAI(s) for which disaster roaming is offered. The RAN node 72 of the second PLMN 70 may broadcast control information similar to that in MINT (e.g., commonPLMNs WithDisasterCondition, applicableDisasterInfoList) in the system information.

The commonPLMNs WithDisasterCondition field included in a System Information Block (SIB) (e.g., SIB Type X) broadcast in a cell may indicate a list of PLMN(s) with disaster conditions which can be commonly applicable to PLMNs sharing the cell.

The applicableDisasterInfoList is a list of disaster conditions applicable to the network(s) specified by the plmn-Identity List in SIB Type 1 (SIB1 ). The first entry in this list indicates disaster information applicable to the network(s) of the first entry in the plmn-Identity List, the second entry in this list indicates disaster information applicable to the network(s) of the second entry in the plmn-Identity List, and so on. Each entry in this list may have a value of noDisasterRoaming, oneBitApproach, commonPLMNs, or dedicatedPLMNs. If an entry in said list takes the value noDisasterRoaming, then disaster roaming is not allowed for the corresponding network(s). If an entry in the list takes the value commonPLMNs, then the PLMN(s) with disaster condition specified in the field complamns WithDisasterCondition applies to this entry. If an entry in this list contains the value dedicatedPLMNs, then the PLMN(s) listed are the PLMN(s) with disaster condition that apply to the network(s) corresponding to that entry.

In step 902, the UE 81 performs PLMN selection. The UE 81 determines that there are no permitted available PLMN(s). Further, the UE 81 detects that a disaster condition applies to the RPLMN, HPLMN, or other predetermined PLMN(s). If a disaster condition applies and no PLMN(s) other than those on the forbidden PLMN list are available, the UE 81 searches for PLMN(s) offering disaster roaming from the forbidden PLMN list. The UE 81 may select a PLMN for disaster roaming according to the specific example described with reference to FIGS. 6 and 7. Here, the UE 81 selects the second PLMN 70 for a disaster roaming attempt.

In step 903, the UE 81 transmits an RRC Setup Request message to the RAN node 72 of the second PLMN 70. The message includes an Establishment Cause indicating “Disaster Roaming”.

In step 904, the RAN node 72 responds to the UE 81 with an RRC Setup message.

In step 905, the UE 81 sets up an RRC connection and sends an RRC Setup Complete message to the RAN node 72. The RRC Setup Complete message includes a Registration Request message indicating disaster roaming. In addition, the RRC Setup Complete message contains the PLMN ID selected by the UE 81 (i. e., PLMN ID “B” of the second PLMN 70). The RRC Setup Complete message also contains the S-NSSAI selected by the UE 81 for disaster roaming.

In step 906, the RAN node 72 selects the AMF 76, a control node of the second PLMN 70, and sends an INITIAL UE MESSAGE message containing the Registration Request message to the selected AMF 76. The RAN node 72 may select an AMF to which the Registration Request message is to be forwarded, taking into account that the establishment cause of the RRC connection is Disaster Roaming. For example, the RAN node 72 may select an AMF designated for disaster roaming. Additionally or alternatively, the RAN node 72 may select an AMF to which the Registration Request message is to be forwarded, considering the S-NSSAI for disaster roaming received from the UE 81. For example, the RAN node 72 may select an AMF associated with the S-NSSAI for disaster roaming. The Establishment Cause may be referred to as Disaster Emergency or Emergency Roaming instead of Disaster Roaming.

According to the operations described in this example embodiment, the UE 81 can learn in advance which network slices are available to disaster roamer UEs in a PLMN without disaster condition (or PLMN offering disaster roaming), either through the RPLMN or the HPLMN. RAN nodes in a PLMN offering disaster roaming can announce an available network slice identifier for disaster roaming (e.g., S-NSSAI) by broadcast. In addition, the UE 81 can inform a PLMN offering disaster roaming in a registration procedure of the network slice identifier (e.g., S-NSSAI) for disaster roaming that the UE 81 wishes to use.

### Third Example Embodiment

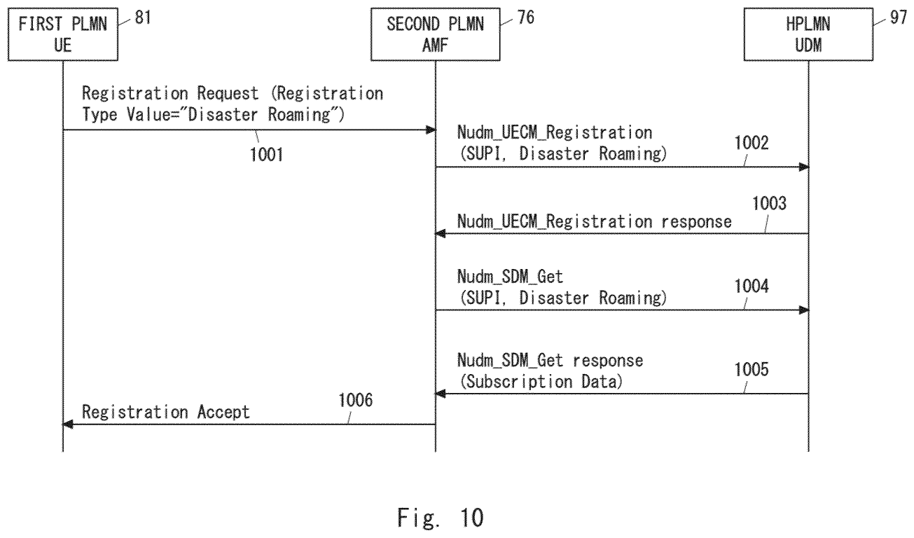

An example configuration of a network system according to this example embodiment is the same as the example shown in FIG. 5. FIG. 10 shows the operation of the AMF 76, a control node of the second PLMN 70, upon receiving a registration request for disaster roaming of the UE 81. The procedure in FIG. 10 (steps 1002-1006) may be performed after the procedure shown in FIG. 9 (step 906) described in the second example embodiment.

In step 1001, the AMF 76 receives a Registration Request message for disaster roaming sent by the UE 81. In the case of a Registration Request for disaster roaming the AMF 76 may skip a UE context transfer procedure to obtain the UE context from the old AMF (e.g., the AMF of the first PLMN 60). This is because the old AMF is likely to be unavailable in the event of disaster roaming. In this case, the AMF 76 may request an unencrypted subscriber identifier (e.g., Subscription Permanent Identifier (SUPI)) from the UE 81.

In step 1002, the AMF 76 requests registration to the UDM 97 of the HPLMN of the UE 81. Specifically, the AMF 76 sends an Nudm UECM_Registration to the UDM 97. At this point, the AMF 76 includes an indication of disaster roaming in the Nudm_UECM_Registration. There are cases where there is no roaming agreement between the second PLMN 70 offering disaster roaming and the HPLMN of the UE 81, in which case the UDM 97 of the HPLMN may reject the request from the AMF 76 of the PLMN 70 offering disaster roaming. By including an indication of disaster roaming in the Nudm_UECM_Registration, the UDM 97 can recognize that the request in question is for disaster roaming. This can prevent the request from being rejected by the UDM 97.

In step 1003, the UDM 97 responds to the AMF 76 with an Nudm_UECM_Registration response.

In step 1004, the AMF 76 sends an Nudm SDM Get to the UDM 97 to request subscription data for the UE 81 from the UDM 97. Similar to step 1002, the AMF 76 may include an indication of disaster roaming in the Nudm_SDM_Get. This can prevent the request from being rejected by the UDM 97.

In step 1005, the UDM 97 provides the requested subscription data of the UE 81 to the AMF 76.

In step 1006, the AMF 76 sends a Registration Accept message to the UE 81.

Example configurations of the RAN nodes 12, 62, and 72, the AMFs 16, 66, and 76, the UDM 97, and the UEs 31 and 81 according to the example embodiments described above are given below.

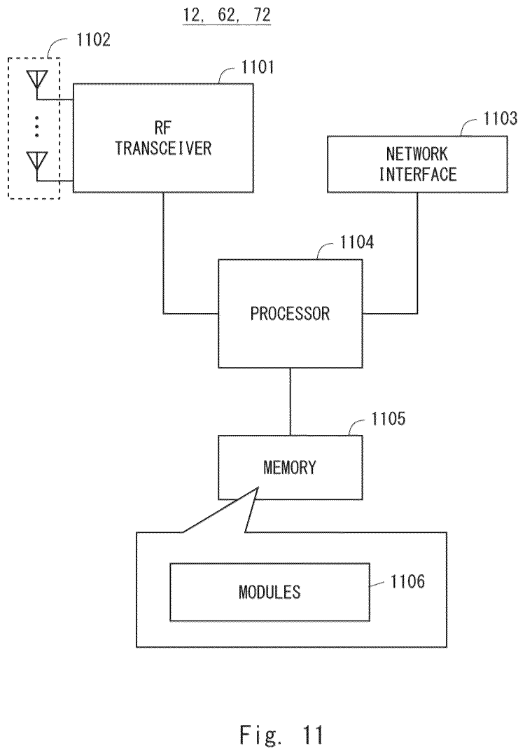

FIG. 11 is a block diagram showing an example configuration of the RAN node 12 according to the example embodiments described above. The RAN nodes 62 and 72 may also have a configuration similar to that of the RAN node 12 shown in FIG. 11. Referring to FIG. 11, the RAN node 12 includes a Radio Frequency transceiver 1101, a network interface 1103, a processor 1104, and a memory 1105.

The RF transceiver 1101 performs analog RF signal processing to communicate with UEs including the UE 31. The RF transceiver 1101 may include a plurality of transceivers. The RF transceiver 1101 is coupled to an antenna array 1102 and the processor 1104. The RF transceiver 1101 receives modulation symbol data from the processor 1104, generates a transmission RF signal, and supplies the transmission RF signal to the antenna array 1102. The RF transceiver 1101 generates a baseband reception signal based on a reception RF signal received by the antenna array 1102 and supplies the baseband reception signal to the processor 1104. The RF transceiver 1101 may include an analog beamformer circuit for beamforming. The analog beamformer circuit includes, for example, a plurality of phase shifters and a plurality of power amplifiers.

The network interface 1103 is used to communicate with network nodes (e.g., other RAN nodes, and control plane nodes and user plane nodes in the core network). The network interface 1103 may include, for example, a Network Interface Card (NIC) that complies with the IEEE 802.3 series.

The processor 1104 performs digital baseband signal processing (data-plane processing) and control-plane processing for radio communication. The processor 1104 may include a plurality of processors. For example, the processor 1104 may include a modem processor (e.g., Digital Signal Processor (DSP)) for performing the digital baseband signal processing and a protocol stack processor (e.g., Central Processing Unit (CPU) or Micro Processing Unit (MPU)) for performing the control-plane processing.

For example, digital baseband signal processing by the processor 1104 may include signal processing in the Service Data Adaptation Protocol (SDAP) layer, the Packet Data Convergence Protocol (PDCP) layer, the Radio Link Control (RLC) layer, the Medium Access Control (MAC) layer, and the Physical (PHY) layer. Control plane processing by the processor 1104 may include processing of Non-Access Stratum (NAS) messages, RRC messages, MAC Control Elements (CE), and Downlink Control Information (DCI).

The processor 1104 may include a digital beamformer module for beamforming. The digital beamformer module may include a Multiple Input Multiple Output (MIMO) encoder and precoder.

The memory 1105 is composed of a combination of a volatile memory and a non-volatile memory. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1105 may include a storage located away from the processor 1104. In this case, the processor 1104 may access the memory 1105 via the network interface 1103 or an I/O interface.

The memory 1105 may store one or more software modules (computer programs) 1106 including instructions and data for performing processing by the RAN node 12 described in the above example embodiments. In some implementations, the processor 1104 may be configured to load and execute the software module(s) 1106 from the memory 1105, thereby performing the processing of the RAN node 12 described in the above example embodiments.

When the RAN node 12 is a Central Unit (CU) (e.g., eNB-CU or gNB-CU) or a CU Control Plane (CP) Unit, the RAN node 12 does not need to include the RF transceiver 1101 (and the antenna array 1102).

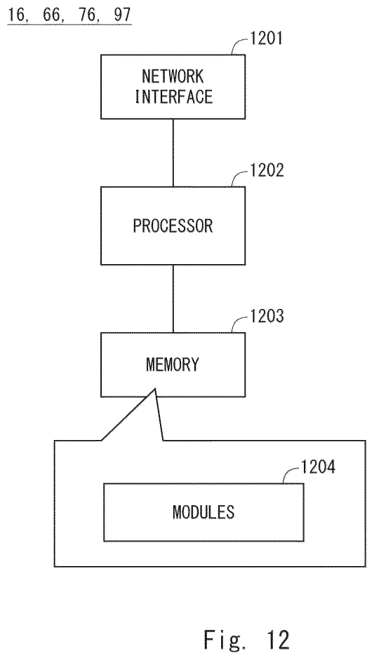

FIG. 12 shows an example configuration of the AMF 16. The AMF 66 and 76 may also have a configuration similar to that of the AMF 16 shown in FIG. 12. The UDM 97 may also have a configuration similar to that of the AMF 16 shown in FIG. 12. Referring to FIG. 12, the AMF 16 includes a network interface 1201, a processor 1202, and a memory 1203.

The network interface 1201 is used, for example, to communicate with other Network Functions (NFs) or nodes. The network interface 1201 may include, for example, a network interface card (NIC) compliant with the IEEE 802.3 series.

The processor 1202 may be, for example, a microprocessor, a Micro Processing Unit (MPU), or a Central Processing Unit (CPU). The processor 1202 may include a plurality of processors.

The memory 1205 is composed of a volatile memory and a non-volatile memory. The memory 1203 may include multiple physically independent memory devices. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1205 may include a storage located away from the processor 1204. In this case, the processor 1204 may access the memory 1205 via the network interface 1203 or an I/O interface.

The memory 1203 may store one or more software modules (computer programs) 1204 including instructions and data for performing processing by the AMF 16 described in the above example embodiments. In some implementations, the processor 1202 may be configured to load and execute the software module(s) 1204 from the memory 1203, thereby performing the processing of the AMF 16 described in the above example embodiments.

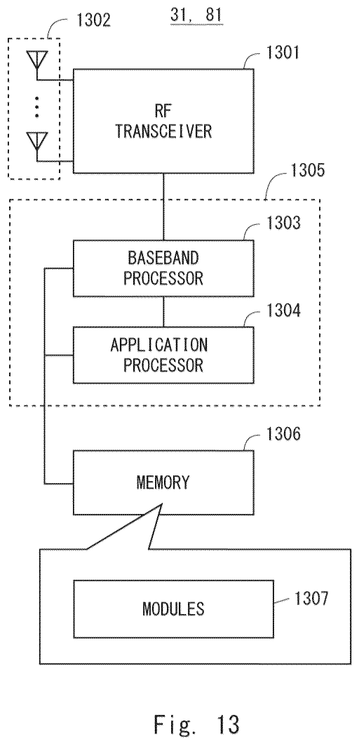

FIG. 13 shows a block diagram of an example configuration of the UE 31. The UE 81 may also have a configuration similar to that of the UE 31 shown in FIG. 12.

The radio frequency (RF) transceiver 1301 performs analog RF signal processing to communicate with RAN nodes (e.g., RAN node 12). The RF transceiver 1301 may include a plurality of transceivers. The analog RF signal processing performed by the RF transceiver 1301 includes frequency up-conversion, frequency down-conversion, and amplification. The RF transceiver 1301 is coupled to the antenna array 1302 and the baseband processor 1303. The RF transceiver 1301 receives modulation symbol data (or OFDM symbol data) from the baseband processor 1303, generates a transmission RF signal, and supplies the transmission RF signal to the antenna array 1302. The RF transceiver 1301 generates a baseband reception signal based on the reception RF signal received by the antenna array 1302 and supplies the baseband reception signal to the baseband processor 1303. The RF transceiver 1301 may include an analog beamformer circuit for beamforming. The analog beamformer circuit includes, for example, a plurality of phase shifters and a plurality of power amplifiers.

The baseband processor 1303 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) Inverse Fast Fourier Transform (IFFT) generation of OFDM symbol data (baseband OFDM signal). On the other hand, the control-plane processing includes communication management of layer 1 (e.g., transmission power control), layer 2 (e.g., radio resource management, and hybrid automatic repeat request (HARQ) processing), and layer 3 (e.g., signaling regarding attachment, mobility, and call management).

For example, the digital baseband signal processing performed by the baseband processor 1303 may include signal processing in the SDAP layer, PDCP layer, RLC layer, MAC layer, and PHY layer. The control-plane processing performed by the baseband processor 1303 may also include processing of Non-Access Stratum (NAS) protocols, RRC protocols, MAC CEs, and DCIs.

The baseband processor 1303 may perform MIMO encoding and precoding for beamforming.

The baseband processor 1303 may include a modem processor (e.g., DSP) that performs the digital baseband signal processing and a protocol stack processor (e.g., CPU or MPU) that performs the control-plane processing. In this case, the protocol stack processor performing the control-plane processing may be integrated with an application processor 1304 described later.

The application processor 1304 may also be referred to as a CPU, an MPU, a microprocessor, or a processor core. The application processor 1304 may include a plurality of processors (processor cores). The application processor 1304 loads a system software program (Operating System (OS)) and various application programs (e.g., a voice call application, a web browser, a mailer, a camera operation application, a music player application) from a memory 1306 or from another memory and executes these programs, thereby providing various functions of the UE 31.

In some implementations, as represented by the dashed line (1305) in FIG. 13, the baseband processor 1303 and the application processor 1304 may be integrated on a single chip. In other words, the baseband processor 1303 and the application processor 1304 may be implemented in a single System on Chip (SoC) device 1305. A SoC device may be referred to as a system Large Scale Integration (LSI) or a chipset.

The memory 1306 is a volatile memory or a non-volatile memory, or a combination thereof. The memory 1306 may include a plurality of physically independent memory devices. The volatile memory is, for example, SRAM, DRAM, or a combination thereof. The non-volatile memory may be MROM, an EEPROM, a flash memory, a hard disk drive, or any combination thereof. The memory 1306 may include, for example, an external memory device that can be accessed by the baseband processor 1303, the application processor 1304, or the SoC 1305. The memory 1306 may include an internal memory device that is integrated into the baseband processor 1303, the application processor 1304, or the SoC 1305. Further, the memory 1306 may include a memory in a Universal Integrated Circuit Card (UICC).

The memory 1306 may store one or more software modules (computer programs) 1307 including instructions and data for processing by the UE 31 described in the above example embodiments. In some implementations, the baseband processor 1303 or the application processor 1304 may load the software module(s) 1307 from the memory 1306 and execute the loaded software module(s) 1307, thereby performing the processing of the UE 31 described in the above example embodiments with reference to the drawings.

The control plane processing and operations performed by the UE 31 described in the above example embodiments may be performed by elements other than the RF transceiver 1301 and the antenna array 1302, i.e., by the memory 1306 storing the software modules 1307 and one or both of the baseband processor 1303 and the application processor 1304.

As described using FIGS. 11, 12, and 13, each of the processors in the RAN nodes, AMFs, UDMs, and UEs according to the above-described example embodiments can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

### Other Example Embodiments

In the example embodiments described above, in the event of a disaster situation, the RAN node 62 may broadcast control information regarding access to a network of another PLMN (e.g., a cell of the RAN node 72). For example, this control information may indicate that the UE 81 is permitted to roam to a network of a pre-specified (or pre-configured) PLMN, that the UE 81 is required to initiate discovery of a network of a pre-specified (or pre-configured) PLMN, or that the UE 81 is permitted to access a network of a particular PLMN. In response to receiving the control information, the UE 81 may initiate disaster roaming in any of the example embodiments described above.

The example embodiments described above are merely examples of applications of the technical ideas obtained by the inventors. These technical ideas are not limited to the example embodiments described above, and various modifications can be made thereto.

For example, the whole or part of the example embodiments disclosed above can be described as, but not limited to, the following supplementary notes.

### (Supplementary Note 1)

An access network node comprising:
a first communication interface configured to communicate with a plurality of User Equipments (UEs) through a cell;
a second communication interface configured to be connected to a first core network of a first Public Land Mobile Network (PLMN) and to a second core network of a second PLMN different from the first PLMN; and
at least one processor configured to:
   receive a Non-Access Stratum message sent from a UE and associated with the first PLMN; and
   if no control node belonging to the first core network of the first PLMN is selectable or available, forward the Non-Access Stratum message to a donor control node belonging to the second core network of the second PLMN.

### (Supplementary Note 2)

The access network node according to Supplementary Note 1, wherein the at least one processor is configured to, if a control node belonging to the first core network of the first PLMN is selected, forward the Non-Access Stratum message to the selected control node.

### (Supplementary Note 3)

The access network node according to Supplementary Note 1 or 2, wherein the at least one processor is configured to receive the Non-Access Stratum message via a Radio Resource Control message containing an identifier of the first PLMN and the Non-Access Stratum message.

(supplementary Note 4)

The access network node according to any one of Supplementary Notes 1 to 3, wherein a Home PLMN of the UE sending the Non-Access Stratum message is the first PLMN.

### (Supplementary Note 5)

The access network node according to any one of Supplementary Notes 1 to 4, wherein the at least one processor is configured to receive a control message from a control node belonging to the first core network specifying the donor control node belonging to the second core network.

(supplementary Note 6)

The access network node according to Supplementary Note 5, wherein the at least one processor is configured to receive the control message in a procedure for setting up or updating configuration data required for interoperation between the control node belonging to the first core network and the access network node.

### (Supplementary Note 7)

The access network node according to Supplementary Note 6, wherein the procedure is an NG Setup procedure, a RAN Configuration Update procedure, or an AMF Configuration Update procedure.

### (Supplementary Note 8)

The access network node according to any one of Supplementary Notes 1 to 7, wherein the at least one processor is configured to broadcast information in the cell indicating a list of available one or more PLMNs, wherein
the list includes an identifier of the first PLMN but does not include an identifier of the second PLMN.

### (Supplementary Note 9)

A method performed by an access network node, the method comprising:
connecting to a first core network of a first Public Land Mobile Network (PLMN) and to a second core network of a second PLMN different from the first PLMN;
receiving a Non-Access Stratum message sent from a User Equipment (UE) and associated with the first PLMN; and
if no control node belonging to the first core network of the first PLMN is selectable or available, forwarding the Non-Access Stratum message to a donor control node belonging to the second core network of the second PLMN.

### (Supplementary Note 10)

A program for causing a computer to perform a method for an access network node, the method comprising:
connecting to a first core network of a first Public Land Mobile Network (PLMN) and to a second core network of a second PLMN different from the first PLMN;
receiving a Non-Access Stratum message sent from a User Equipment (UE) and associated with the first PLMN; and
if no control node belonging to the first core network of the first PLMN is selectable or available, forwarding the Non-Access Stratum message to a donor control node belonging to the second core network of the second PLMN.

### (Supplementary Note 11)

A control node to be used in a core network of a first Public Land Mobile Network (PLMN), the control node comprising:
a communication interface configured to be connected to an access network node; and
at least one processor configured to send a control message to the access network node specifying a donor control node belonging to a core network of a second PLMN different from the first PLMN to which the control node belongs, wherein
the control message causes the access network node to, if no control node belonging to the core network of the first PLMN is selectable or available, forward to the donor control node of the second PLMN a Non-Access Stratum message that is transmitted from a User Equipment (UE) and is associated with the first PLMN.

### (Supplementary Note 12)

The control node according to Supplementary Note 11, wherein the at least one processor is configured to send the control message in a procedure for setting up or updating configuration data required for interoperation between the control node and the access network node.

### (Supplementary Note 13)

The control node according to Supplementary Note 12, wherein the procedure is an NG Setup procedure, a RAN Configuration Update procedure, or an AMF Configuration Update procedure.

### (Supplementary Note 14)

A method performed by a control node used in a core network of a first Public Land Mobile Network (PLMN), the method comprising:
sending a control message to an access network node specifying a donor control node belonging to a core network of a second PLMN different from the first PLMN to which the control node belongs, wherein
the control message causes the access network node to, if no control node belonging to the core network of the first PLMN is selectable or available, forward to the donor control node of the second PLMN a Non-Access Stratum message that is transmitted from a User Equipment (UE) and is associated with the first PLMN.

### (Supplementary Note 15)

A program for causing a computer to perform a method for a control node used in a core network of a first Public Land Mobile Network (PLMN), the method comprising:
sending a control message to an access network node specifying a donor control node belonging to a core network of a second PLMN different from the first PLMN to which the control node belongs, wherein
the control message causes the access network node to, if no control node belonging to the core network of the first PLMN is selectable or available, forward to the donor control node of the second PLMN a Non-Access Stratum message that is transmitted from a User Equipment (UE) and is associated with the first PLMN.

### (Supplementary Note 16)

A User Equipment (UE) comprising:
at least one memory; and
at least one processor coupled to the at least one memory and configured to:
   store in the at least one memory a list of one or more Public Land Mobile Networks (PLMNs) to be used during a disaster condition;
   store in the at least one memory a list of one or more network slice identifiers for disaster roaming associated with each PLMN in the list of one or more PLMNs;
   select a PLMN for disaster roaming from the list of one or more PLMNs;
   select at least one network slice identifier for disaster roaming from the list of one or more network slice identifiers for disaster roaming associated with the selected PLMN for disaster roaming; and
   transmit a registration request message indicating the selected PLMN for disaster roaming and indicating the selected network slice identifier for disaster roaming to a core network of the selected PLMN for disaster roaming.

### (Supplementary Note 17)

The UE according to Supplementary Note 16, wherein the at least one processor is configured to transmit, to a radio access network of the selected PLMN for disaster roaming, a Radio Resource Control message containing the registration request message and containing the selected network slice identifier for disaster roaming.

### (Supplementary Note 18)

The UE according to Supplementary Note 17, wherein the Radio Resource Control message is an RRC setup complete message.

### (Supplementary Note 19)

The UE according to any one of Supplementary Notes 16 to 18, wherein the at least one processor is configured to, if a radio access network of one PLMN included in the stored list of one or more PLMNs broadcasts disaster-related information indicating that disaster roaming is offered, and if the disaster-related information indicates at least one network slice identifier included in the stored list of one or more network slice identifiers for disaster roaming associated with the one PLMN, select the one PLMN as the PLMN for disaster roaming.

### (Supplementary Note 20)

The UE according to Supplementary Note 19, wherein the disaster-related information indicates that disaster roaming is offered for a Registered PLMN in which the UE is registered or for a Home PLMN of the UE.

### (Supplementary Note 21)

The UE according to any one of Supplementary Notes 16 to 20, wherein the at least one processor is configured to receive, from a Home PLMN of the UE or a Registered PLMN to which the UE is registered, the list of one or more PLMNs to be used during the disaster condition and the list of one or more network slice identifiers for disaster roaming associated with each PLMN in the list of one or more PLMNs.

(supplementary Note 22)

The UE according to any one of Supplementary Notes 16 to 20, wherein the at least one processor is configured to receive, from a Home PLMN of the UE or a Registered PLMN to which the UE is registered, a list of one or more combinations, each of which is a combination of a PLMN to be used during the disaster condition and one or more network slice identifiers for disaster roaming.

### (Supplementary Note 23)

A method performed by a User Equipment (UE), the method comprising:
storing in the at least one memory a list of one or more Public Land Mobile Networks (PLMNs) to be used during a disaster condition;
storing in the at least one memory a list of one or more network slice identifiers for disaster roaming associated with each PLMN in the list of one or more PLMNs;
selecting a PLMN for disaster roaming from the list of one or more PLMNs;
selecting at least one network slice identifier for disaster roaming from the list of one or more network slice identifiers for disaster roaming associated with the selected PLMN for disaster roaming; and
transmitting a registration request message indicating the selected PLMN for disaster roaming and indicating the selected network slice identifier for disaster roaming to a core network of the selected PLMN for disaster roaming.

### (Supplementary Note 24)

A program for causing a computer to perform a method for a User Equipment (UE), the method comprising:
storing in the at least one memory a list of one or more Public Land Mobile Networks (PLMNs) to be used during a disaster condition;
storing in the at least one memory a list of one or more network slice identifiers for disaster roaming associated with each PLMN in the list of one or more PLMNs;
selecting a PLMN for disaster roaming from the list of one or more PLMNs;
selecting at least one network slice identifier for disaster roaming from the list of one or more network slice identifiers for disaster roaming associated with the selected PLMN for disaster roaming; and
transmitting a registration request message indicating the selected PLMN for disaster roaming and indicating the selected network slice identifier for disaster roaming to a core network of the selected PLMN for disaster roaming.

### (Supplementary Note 25)

A core network node of a Home Public Land Mobile Network (HPLMN) of a User Equipment (UE) or a registered PLMN in which the UE is registered, the core network node comprising:
at least one memory; and
at least one processor coupled to the at least one memory and configured to:
   provide the UE with a first list of one or more PLMNs to be used during a disaster condition; and
   provide the UE with a second list of one or more network slice identifiers for disaster roaming associated with each PLMN in the list of one or more PLMNs.

### (Supplementary Note 26)

The core network node according to Supplementary Note 25, wherein the first list and the second list are an integrated list, wherein
the integrated list is a list of one or more combinations, each of which is a combination of a PLMN to be used during the disaster condition and one or more network slice identifiers for disaster roaming.

### (Supplementary Note 27)

A method performed by a core network node of a Home Public Land Mobile Network (HPLMN) of a User Equipment (UE) or a registered PLMN in which the UE is registered, the method comprising:
providing the UE with a first list of one or more PLMNs to be used during a disaster condition; and
providing the UE with a second list of one or more network slice identifiers for disaster roaming associated with each PLMN in the list of one or more PLMNs.

### (Supplementary Note 28)

A program for causing a computer to perform a method for a core network node of a Home Public Land Mobile Network (HPLMN) of a User Equipment (UE) or a registered PLMN in which the UE is registered, the method comprising:
providing the UE with a first list of one or more PLMNs to be used during a disaster condition; and
providing the UE with a second list of one or more network slice identifiers for disaster roaming associated with each PLMN in the list of one or more PLMNs.

### (Supplementary Note 29)

An access network node of a Public Land Mobile Network (PLMN) offering disaster roaming, the access network node comprising:
at least one memory; and
at least one processor coupled to the at least one memory and configured to broadcast disaster-related information in a cell indicating that disaster roaming is offered, wherein
the disaster-related information includes a list of one or more network slice identifiers for disaster roaming.

### (Supplementary Note 30)

The access network node according to Supplementary Note 29, wherein the at least one processor is configured to:
receive, from a User Equipment (UE), a Radio Resource Control message containing a registration request message to the PLMN offering disaster roaming and containing at least one network slice identifier for disaster roaming included in the list; and
select a core network node to which the registration request message is to be forwarded based on the at least one network slice identifier for disaster roaming contained in the Radio Resource Control message.

### (Supplementary Note 31)

The access network node according to Supplementary Note 29, wherein the at least one processor is configured to:
receive, from a User Equipment (UE), a Non-Access Stratum message associated with disaster roaming and associated with at least one network slice identifier for disaster roaming included in the list; and
select a core network node to which the Non-Access Stratum message is to be forwarded based on the association with the disaster roaming and the association with the at least one network slice identifier for disaster roaming.

### (Supplementary Note 32)

The access network node according to any one of Supplementary Notes 29 to 31, wherein the disaster-related information further includes a list of one or more Public Land Mobile Networks (PLMNs) with a disaster condition for which disaster roaming is offered.

### (Supplementary Note 33)

A method performed by an access network node of a Public Land Mobile Network (PLMN) offering disaster roaming, the method comprising:
broadcasting disaster-related information in a cell indicating that disaster roaming is offered, wherein
the disaster-related information includes a list of one or more network slice identifiers for disaster roaming.

### (Supplementary Note 34)

A program for causing a computer to perform a method for an access network node of a Public Land Mobile Network (PLMN) offering disaster roaming, the method comprising:
broadcasting disaster-related information in a cell indicating that disaster roaming is offered, wherein
the disaster-related information includes a list of one or more network slice identifiers for disaster roaming.

### (Supplementary Note 35)

A core network node of a Public Land Mobile Network (PLMN) offering disaster roaming, the core network node comprising:
at least one memory; and
at least one processor coupled to the at least one memory and configured to:
   receive a registration request from a User Equipment (UE); and
   if the registration request indicates disaster roaming, include an indication of disaster roaming in a message to be sent to a control node that is located in a Home PLMN of the UE and manages subscription information for the UE.

### (Supplementary Note 36)

The core network node according to Supplementary Note 35, wherein the indication of disaster roaming causes the control node not to reject a request indicated in the message even if there is no roaming agreement between a PLMN to which the core network node belongs and the Home PLMN.

### (Supplementary Note 37)

The core network node according to Supplementary Note 35 or 36, wherein the message indicates a request for registration of the core network node with the control node or a request for transmission of the subscription information for the UE.

### (Supplementary Note 38)

The core network node according to any one of Supplementary Notes 35 to 37, wherein
the core network node is an Access and Mobility Management Function (AMF), and
the control node is a Unified Data Management (UDM).

### (Supplementary Note 39)

The core network node according to any one of Supplementary Notes 35 to 38, wherein the at least one processor is configured to, if the registration request indicates disaster roaming, skip a procedure for requesting a core network node in a PLMN with which the UE was previously registered to transfer a UE context for the UE.

### (Supplementary Note 40)

A method performed by a core network node of a Public Land Mobile Network (PLMN) offering disaster roaming, the method comprising:
receiving a registration request from a User Equipment (UE); and
if the registration request indicates disaster roaming, including an indication of disaster roaming in a message to be sent to a control node that is located in a Home PLMN of the UE and manages subscription information for the UE.

### (Supplementary Note 41)

A program for causing a computer to perform a method for a core network node of a Public Land Mobile Network (PLMN) offering disaster roaming, the method comprising:
receiving a registration request from a User Equipment (UE); and
if the registration request indicates disaster roaming, including an indication of disaster roaming in a message to be sent to a control node that is located in a Home PLMN of the UE and manages subscription information for the UE.

This application is based upon and claims the benefit of priority from Japanese Patent Application No. 2022-019381, filed on Feb. 10, 2022, the disclosure of which is incorporated herein in its entirety by reference.

### REFERENCE SIGNS LIST

10 PLMN
11 RAN
12 RAN Node
15 Core Network
16 AMF
25 Core Network
31 UE
60 PLMN
61 RAN
62 RAN Node
66 AMF
70 PLMN
71 RAN
72 RAN Node
76 AMF
81 UE
97 UDM
1104 Processor
1105 Memory
1106 Modules
1202 Processor
1203 Memory
1204 Modules
1303 Baseband Processor
1304 Application Processor
1306 Memory
1307 Modules

What is claimed is:

1.-8. (canceled)

9. A method performed by an access network node, the method comprising:
connecting to a first core network of a first Public Land Mobile Network (PLMN) and to a second core network of a second PLMN different from the first PLMN;
receiving a Non-Access Stratum message sent from a User Equipment (UE) and associated with the first PLMN; and
if no control node belonging to the first core network of the first PLMN is selectable or available, forwarding the Non-Access Stratum message to a donor control node belonging to the second core network of the second PLMN.

10.-13. (canceled)

14. A method performed by a control node used in a core network of a first Public Land Mobile Network (PLMN), the method comprising:
sending a control message to an access network node specifying a donor control node belonging to a core network of a second PLMN different from the first PLMN to which the control node belongs, wherein
the control message causes the access network node to, if no control node belonging to the core network of the first PLMN is selectable or available, forward to the donor control node of the second PLMN a Non-Access Stratum message that is transmitted from a User Equipment (UE) and is associated with the first PLMN.

15.-22. (canceled)

23. A method performed by a User Equipment (UE), the method comprising:
storing in the at least one memory a list of one or more Public Land Mobile Networks (PLMNs) to be used during a disaster condition;
storing in the at least one memory a list of one or more network slice identifiers for disaster roaming associated with each PLMN in the list of one or more PLMNs;
selecting a PLMN for disaster roaming from the list of one or more PLMNs;
selecting at least one network slice identifier for disaster roaming from the list of one or more network slice identifiers for disaster roaming associated with the selected PLMN for disaster roaming; and
transmitting a registration request message indicating the selected PLMN for disaster roaming and indicating the selected network slice identifier for disaster roaming to a core network of the selected PLMN for disaster roaming.

24.-41. (canceled)

42. The method according to claim 9, further comprising, if a control node belonging to the first core network of the first PLMN is selected, forwarding the Non-Access Stratum message to the selected control node.

43. The method according to claim 9, wherein the receiving comprises receiving the Non-Access Stratum message via a Radio Resource Control message containing an identifier of the first PLMN and the Non-Access Stratum message.

44. The method according to claim 9, wherein a Home PLMN of the UE sending the Non-Access Stratum message is the first PLMN.

45. The method according to claim 9, further comprising receiving a control message from a control node belonging to the first core network specifying the donor control node belonging to the second core network.

46. The method according to claim 45, wherein the receiving the control message comprises receiving the control message in a procedure for setting up or updating configuration data required for interoperation between the control node belonging to the first core network and the access network node.

47. The method according to claim 46, wherein the procedure is an NG Setup procedure, a RAN Configuration Update procedure, or an AMF Configuration Update procedure.

48. The method according to claim 9, further comprising broadcasting information in a cell indicating a list of available one or more PLMNs, wherein
the list includes an identifier of the first PLMN but does not include an identifier of the second PLMN.

49. The method according to claim 14, wherein the sending comprises sending the control message in a procedure for setting up or updating configuration data required for interoperation between the control node and the access network node.

50. The method according to claim 49, wherein the procedure is an NG Setup procedure, a RAN Configuration Update procedure, or an AMF Configuration Update procedure.

51. The method according to claim 23, wherein the transmitting comprises transmitting, to a radio access network of the selected PLMN for disaster roaming, a Radio Resource Control message containing the registration request message and containing the selected network slice identifier for disaster roaming.

52. The method according to claim 51, wherein the Radio Resource Control message is an RRC setup complete message.

53. The method according to claim 23, wherein the selecting the PLMN for disaster roaming comprises, if a radio access network of one PLMN included in the stored list of one or more PLMNs broadcasts disaster-related information indicating that disaster roaming is offered, and if the disaster-related information indicates at least one network slice identifier included in the stored list of one or more network slice identifiers for disaster roaming associated with the one PLMN, selecting the one PLMN as the PLMN for disaster roaming.

54. The method according to claim 53, wherein the disaster-related information indicates that disaster roaming is offered for a Registered PLMN in which the UE is registered or for a Home PLMN of the UE.

55. The method according to claim 23, further comprising receiving, from a Home PLMN of the UE or a Registered PLMN to which the UE is registered, the list of one or more PLMNs to be used during the disaster condition and the list of one or more network slice identifiers for disaster roaming associated with each PLMN in the list of one or more PLMNs.

56. The method according to claim 23, further comprising receiving, from a Home PLMN of the UE or a Registered PLMN to which the UE is registered, a list of one or more combinations, each of which is a combination of a PLMN to be used during the disaster condition and one or more network slice identifiers for disaster roaming.
